(19) United States
(12) Patent Application Publication
(10) Pub. No.: US 2016/0085757 A1
(43) Pub. Date: Mar. 24, 2016

(54) INFORMATION DISPLAY DEVICE, INFORMATION DISPLAY METHOD, AND STORAGE MEDIUM

(71) Applicant: CASIO COMPUTER CO., LTD., Tokyo (JP)

(72) Inventor: Takahiko RACHI, Tokyo (JP)

(73) Assignee: CASIO COMPUTER CO., LTD., Tokyo (JP)

(21) Appl. No.: 14/838,721

(22) Filed: Aug. 28, 2015

(30) Foreign Application Priority Data
Sep. 22, 2014 (JP) 2014-192101

(51) Int. Cl. G06F 17/30

(52) U.S. Cl. CPC G06F 17/3053; G06F 17/30554

(57) ABSTRACT

An information display device includes a communication unit which communicates with another device; a display unit; a memory; and a processor which performs a transmitting process to transmit a search history of the information display device to the another device via the communication unit, a receiving process to receive a search history of the another device via the communication unit, and a control process to display, as a candidate to be searched for on the display unit, a word and/or phrase included in the search history received by the receiving process.

### BACKGROUND OF THE INVENTION

1. Field of the Invention

The present invention relates to an information display device, an information display method, and a storage medium.

2. Description of Related Art

Typical electronic dictionaries have convenient search functions, such as functions of history search and jump search.

The function of “history search” refers to a function of registering words/phrases (headwords) which were searched for as history information and conducting searches through the use of the history information. With such a history search function, when a user searches for a word/phrase which was searched for in the past, the user does not need to input the string but has only to select the word/phrase from the history information, leading to an easy search.

The function of “jump search” refers to a function of allowing a user to specify a string in explanation information displayed as the result of a search of a word/phrase, and further conducting a search for the specified string as a new targeted word/phrase. With such a jump search function, when a user searches for a first word/phrase, the user can further search for a second word/phrase related to the first word/phrase in the series of the search and can easily allow the device to display the explanation information on the second word/phrase.

Patent Literature 1 (Japanese Unexamined Patent Application Publication No. 2012-022638) discloses an attempt to overcome inconveniences in history searches and jump searches. In Patent Literature 1, in particular, when a word for which a jump search was conducted in the past is to be searched through a history search, the history of the word is displayed such that the information is categorized into a group of information on the original place before the jumping and a group of information on the jump destination. The technique disclosed in Patent Literature 1 thus helps a user to enhance learning efficiency.

Even the electronic dictionary as disclosed in Patent Literature 1 that can make effective use of search histories, however, is limited to a use of search histories of the user's own electronic dictionary and further improvements are desired. For example, when multiple students are studying using the same textbooks in a school classroom, each student has to individually input a target word/phrase (string) in full spelling to search for the word/phrase although many of the students often search for the same word/phrase.

If a user could make use of search histories of other users' devices, the user could enhance search efficiency with his/her own device and this would enhance learning efficiencies of the whole class. Unfortunately, however, not many electronic dictionaries currently on the market have a function of communicating with other devices. There are electronic dictionaries having Wireless Fidelity (Wi-Fi) function, but they merely acquire and display information on the Internet and could not make use of search histories of other devices.

A main object of the present invention is to provide an information display device that can make use of search histories of another device(s) to enhance a user's search efficiency.

### SUMMARY OF THE INVENTION

An information display device according to the present invention includes a communication unit which communicates with another device; a display unit; a memory; and a processor which performs a transmitting process to transmit a search history of the information display device to the another device via the communication unit, a receiving process to receive a search history of the another device via the communication unit, and a control process to display, as a candidate to be searched for on the display unit, a word and/or phrase included in the search history received by the receiving process.

### EFFECTS OF THE INVENTION

The present invention allows a device to make use of search histories of another device(s), leading to enhancement of a user's search efficiency.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 shows an example mode for usage of electronic dictionaries;

FIG. 2 is a plan view showing a schematic configuration of an electronic dictionary;

FIG. 3 is a block diagram schematically showing the control circuit of an electronic dictionary;

FIG. 4A shows an example reference table;

FIG. 4B shows an example criterion function;

FIG. 4C shows an example history list;

FIG. 4D shows an example aggregate list;

FIG. 5 is a flowchart of an information display process proceeding over time;

FIG. 6 is a diagram to explain a step in the information display process; and

FIG. 7 is a view to explain an example operation of an electronic dictionary.

### EMBODIMENTS TO CARRY OUT THE INVENTION

A preferred embodiment, in which an information display device of the present invention is applied to an electronic dictionary, will now be described below with reference to the drawings. In this description, the term “word(s)/phrase(s)” refers to “word(s) and/or phrase(s)”. In other words, “word(s)/phrase(s)” can be only word(s), only phrase(s), or a mixture of word(s) and phrase(s).

### [Mode for Usage]

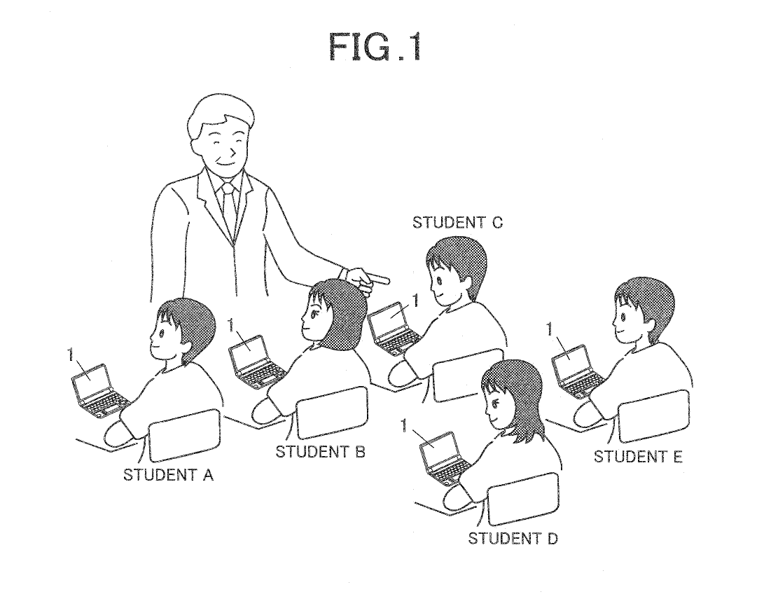

In this embodiment, multiple electronic dictionaries 1 are used at the same time within a certain range, with the electronic dictionaries 1 connected to one another for mutual communication, as shown in FIG. 1. An assumed communication method is near field communication within a radius of about 10 m to 100 m. Examples of communication formats include Bluetooth (registered trademark), IrDA (infrared communication), and IrSS (infrared communication). Bluetooth (registered trademark) is preferably used.

In this embodiment, five electronic dictionaries 1 of students A to E are connected with one another for mutual communication. The description focuses, in particular, on the electronic dictionary 1 of student A.

### [External Configuration]

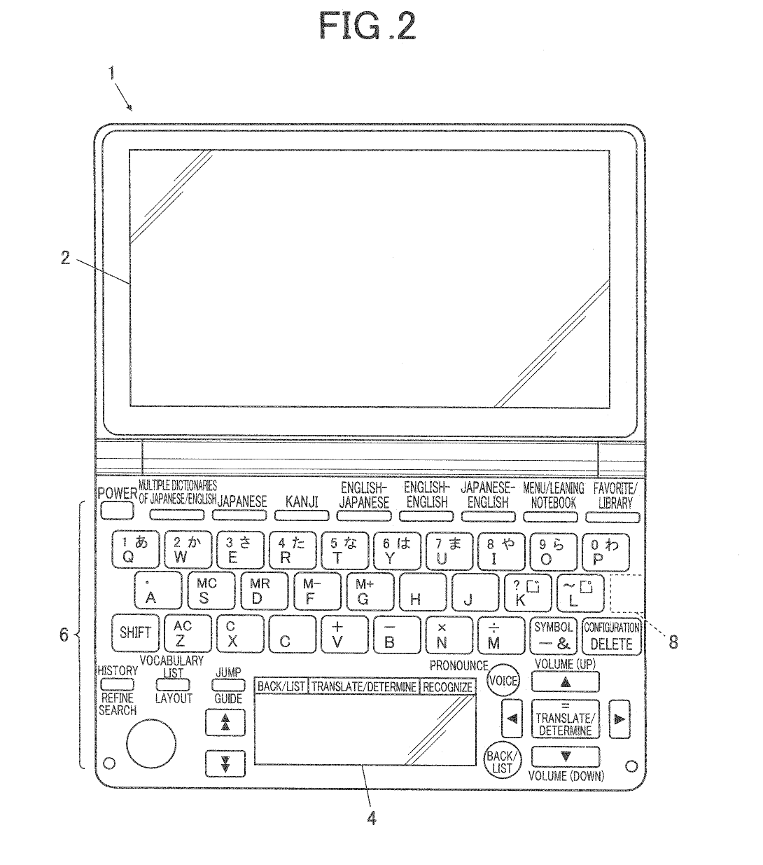

As shown in FIG. 2, the electronic dictionary 1 includes a main display 2, a sub-display 4, a key group 6, and a transceiver 8 as main components.

The main display 2 and the sub-display 4 are parts on which various data items, such as characters and symbols, are displayed according to a user's operation on the key group 6.

The main display 2 and the sub-display 4 are composed of, for example, liquid crystal displays (LCDs) or electroluminescent displays (ELDs).

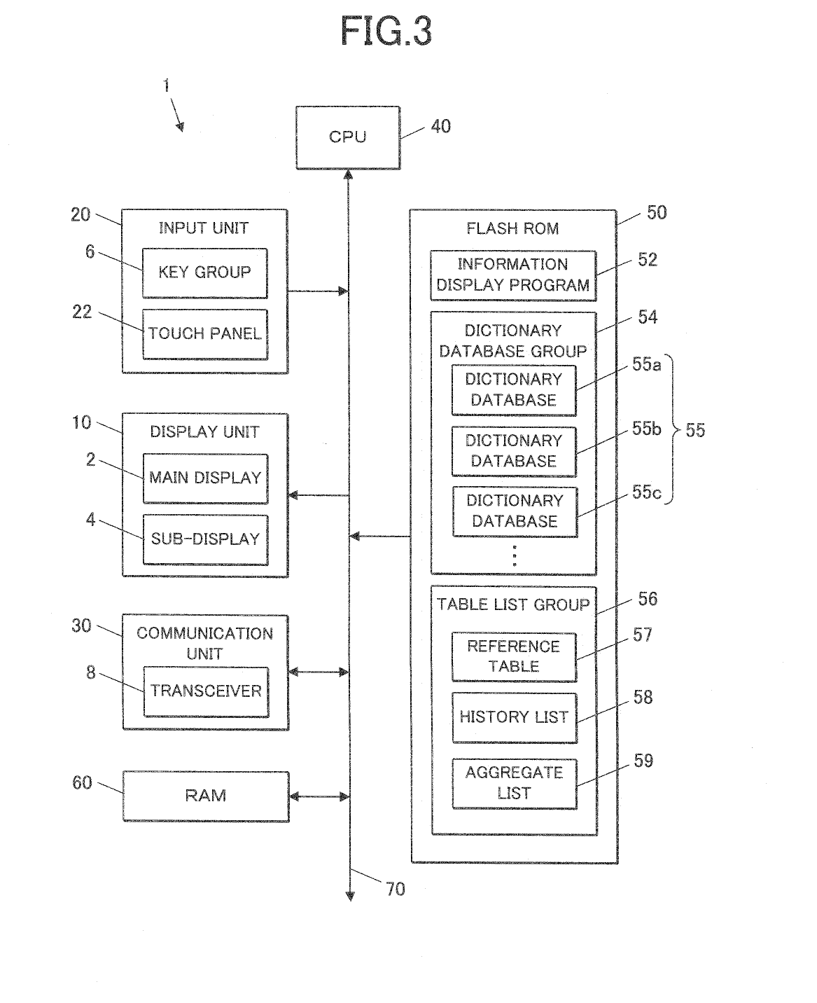

The main display 2 and the sub-display 4 are each integrated with a so-called touch panel (see FIG. 3) to receive operations, such as handwriting inputs.

The key group 6 includes various keys to receive inputs from a user for operation of the electronic dictionary 1.

The transceiver 8 is integrated with or built into the electronic dictionary 1.

### [Internal Configuration]

As shown in FIG. 3, the electronic dictionary 1 includes a display unit 10, an input unit 20, a communication unit 30, a central processing unit (CPU) 40, a flash read only memory (ROM) 50, and a random access memory (RAM) 60 as main components. The components are connected to one another via a bus 70 so that data communications can be performed with one another.

The display unit 10 includes the main display 2 and the sub-display 4.

The display unit 10 displays various information items on the main display 2 and the sub-display 4 in response to display signals input from the CPU 40.

The input unit 20 includes the key group 6 and the touch panel 22.

The input unit 20 outputs signals corresponding to pressed keys and positions on the touch panel 22 to the CPU 40.

The communication unit 30 includes the transceiver 8 to communicate with other users' electronic dictionaries 1.

The transceiver 8 of the communication unit 30 transmits data of the user's own electronic dictionary 1 to other users' electronic dictionaries 1 and receives data of other users' electronic dictionaries 1, in response to instruction signals input from the CPU 40, the CPU 40 serving as a transmitting means and a receiving means.

The CPU 40 carries out processes based on predetermined programs according to input instructions and gives instructions to and transfers data to the function units. The CPU 40 thus comprehensively controls the electronic dictionary 1.

Specifically, the CPU 40 reads out various programs stored in the flash ROM 50 in response to operation signals input from the input unit 20 and carries out processes in accordance with the programs. The CPU 40 stores the results of the processes in the RAM 60 and outputs the results to the display unit 10 as appropriate.

The flash ROM 50 is a memory to store programs and data to perform various functions of the electronic dictionary 1.

The flash ROM 50 stores an information display program 52, a dictionary database group 54, and a table list group 56 etc.

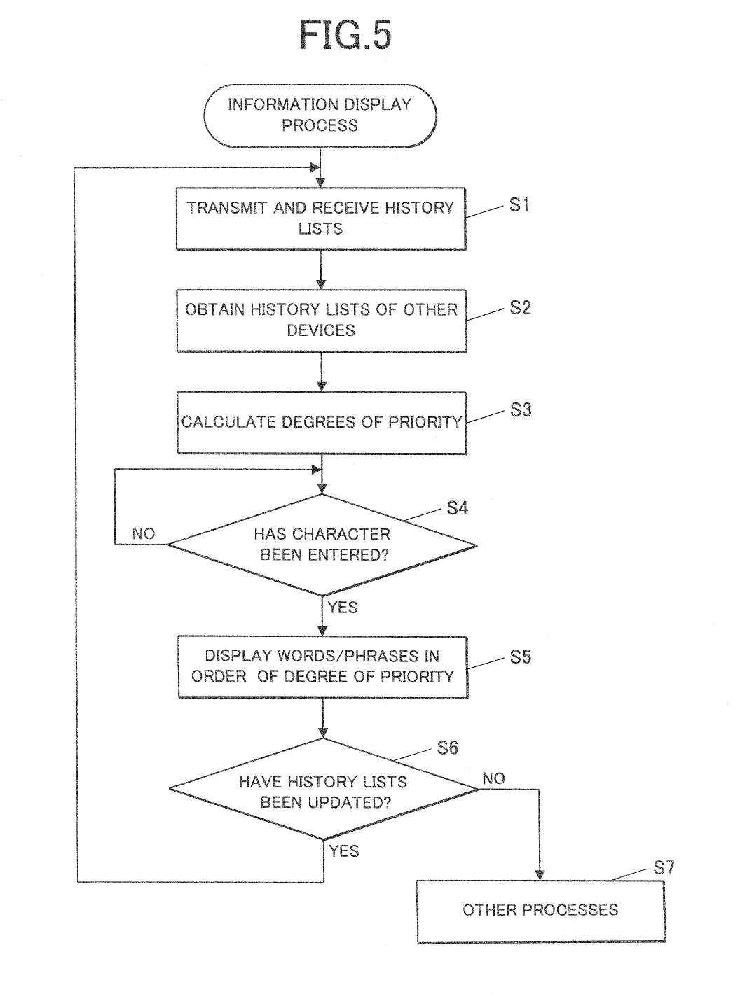

The information display program 52 is a program to allow the CPU 40 to carry out an information display process (see FIG. 5), which is described later.

The dictionary database group 54 includes multiple dictionary databases 55.

In this embodiment, the dictionary databases 55 include a dictionary database 55a of a Japanese dictionary, a dictionary database 55b of a kanji dictionary, and a dictionary database 55c of an English-Japanese dictionary etc.

Each of the dictionary databases 55 includes multiple words/phrases (headwords) and the explanatory information including the meanings of the words/phrases, with each word/phrase and the corresponding explanatory information being associated with each other.

The table list group 56 includes a reference table 57, a history list 58, and an aggregate list 59 etc.

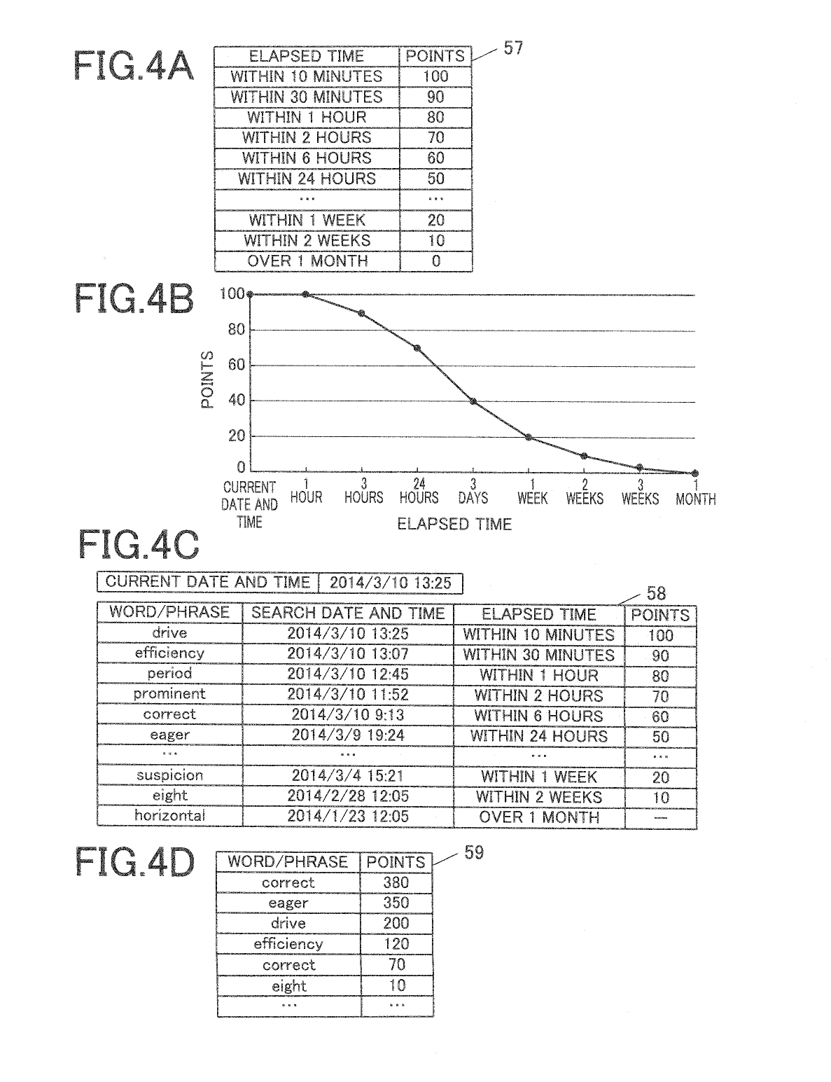

As shown in FIG. 4A, the reference table 57 is a table in which elapsed time and points are associated with each other. The term “elapsed time” refers to the time from the date and time at which a user searches for a word/phrase to the current date and time. The term “points” refers to a value varying depending on the elapsed time. In this embodiment, the points decrease as the elapsed time increases. The relationship between the elapsed time and the points can be modified as appropriate.

Instead of the reference table 57, a criterion function table defining a relationship between the elapsed time and the points may be stored to be used (see FIG. 4B).

As shown in FIG. 4C, the history list 58 is a list of search histories of words/phrases (headwords). Specifically, in the history list 58, a word/phrase, a search date and time, elapsed time, and points are associated with one another. The term “search date and time” refers to an actual date and time at which a user searches for a word/phrase. In the history list 58, the elapsed time is calculated from the search date and time and the current date and time for each word/phrase, the elapsed time is checked against the reference table 57, and the points are finally calculated. When the elapsed time exceeds a given period of time, the relevant word/phrase is removed (deleted) from the history list 58. In the example of FIG. 4C, the word “horizontal” is removed from the history list 58.

As shown in FIG. 4D, the aggregate list 59 is a table in which words/phrases (headwords) and points are associated with each other. The aggregate list 59 is created based on the history lists 58 of all the electronic dictionaries 1 including the electronic dictionaries 1 other than the user's own electronic dictionary 1.

The RAM 60 is a memory to temporarily store, for example, various programs to be executed by the CPU 40 and the data related to the execution of the programs.

The information display process of the electronic dictionary 1 (or the information display method using the electronic dictionary 1) and an example operation of the electronic dictionary 1 will now be described. The description below is based on the assumption that students A to E use English-Japanese dictionaries of their electronic dictionaries 1 in an English class.

### [Information Display Process]

The information display process is carried out by the CPU 40 reading out the information display program 52 from the flash ROM 50. FIG. 5 shows the flowchart of the information display process. This process is carried out based on the assumption that multiple electronic dictionaries 1 are connected with one another for mutual communication.

First, the CPU 40 transmits the history list 58 of the user's own electronic dictionary 1 to the other users' electronic dictionaries 1 via the transceiver 8, and receives the history lists 58 of the other users' electronic dictionaries 1 via the transceiver 8 (Step S1).

The CPU 40 then obtains the received history lists 58 of the other users' electronic dictionaries 1 (Step S2), creates an aggregate list 59 of words/phrases and calculates the degrees of priority based on the obtained history lists 58 of the other users' electronic dictionaries 1 (Step S3).

Specifically, in Step S3, the CPU 40 calculates points for each word/phrase based on the history lists 58 of the other users' electronic dictionaries 1 and the history list 58 of the user's own electronic dictionary 1 to create the aggregate list 59. The points represent the degrees of priority for output of the words/phrases.

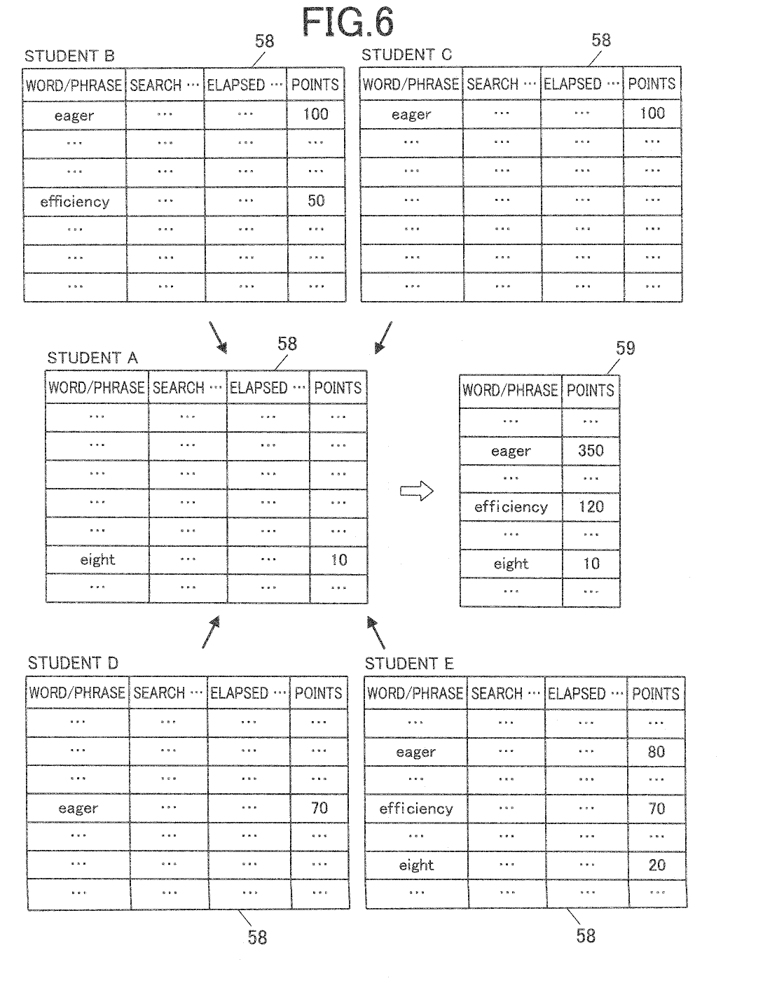

The process of creating the aggregate list 59 in student A's electronic dictionary 1 will now be described in detail on the assumption that the history lists 58 as shown in FIG. 6 are stored in the electronic dictionaries 1.

A focus is put on a first word “eager” in the history list 58 received from student B. The student A's history list 58 does not include the word “eager”, whereas the student B's history list 58 includes this word with 100 points, the student C's history list 58 includes this word with 100 points, the student D's history list 58 includes this word with 70 points, and the student E's history list 58 includes this word with 80 points. Thus, the word “eager” having 350 points is added to the student A's aggregate list 59.

In a similar manner, the student A's history list 58 does not include the word “efficiency”, the student B's history list 58 includes this word with 50 points, the students C and D's history lists 58 do not include this word, and the student E's history list 58 includes this word with 70 points. Thus, the word “efficiency” having 120 points is added to the student A's aggregate list 59.

The words/phrases included in the history lists 58 received from other students are thus extracted one by one and new words/phrases are added to the student A's aggregate list 59 in such a way that the same words/phrases are not redundantly added.

As to the word “eight” (20 points) in the history list 58 received from student E, the students B, C, and D's history lists 58 do not include this word and the student A's history list 58 includes this word with 10 points. This indicates that student A searched for the word “eight” in the past and that student A is less likely to search for this word again. So, the word “eight” having 10 points is added to the student A's aggregate list 59, which 10 points is obtained by subtracting 10 points in the student A's history list 58 from 20 points in the student E's history list 58. Thus, for a word/phrase which is already included in the student A's history list 58, the points in the student A's history list 58 is subtracted. Alternatively, 0 point may be assigned to a word/phrase which is already included in the student A's history list 58 not to add the word/phrase to the aggregate list 59.

As a result of such processes, the aggregate list 59 as shown in FIG. 6 is created in the student A's electronic dictionary 1.

In response to the creation of the aggregate list 59 and the determination of the degrees of priority of the words/phrases included in the aggregate list 59, the CPU 40 waits for a character to be entered for a dictionary search by a user (Step S4). If a character is entered for a dictionary search (Step S4; Yes), the CPU 40 extracts words/phrases whose beginning parts match the character entered by the user, from among the words/phrases included in the aggregate list 59 of the user's own electronic dictionary 1, in a descending order of degree of priority, and displays the extracted words/phrases on the main display 2 as candidates to be searched for (Step S5). The CPU 40 then searches the English-Japanese dictionary and additionally displays, at the end of the words/phrases extracted from the aggregate list 59, the candidate words/phrases extracted from the English-Japanese dictionary.

Suppose student A enters a character “e”, for example. The aggregate list 59 of the student A's electronic dictionary 1 includes “eager”, “efficiency”, and “eight” as words/phrases beginning with “e”, with the order of degree of priority of these words being “eager” (high)>“efficiency” (medium)>“eight” (low). Thus the words “eager”, “efficiency”, and “eight” are displayed on the main display 2 in this order as candidates to be searched for in response to student A's entering “e”.

In Step S5, the CPU 40 may display, as candidates to be searched for on the main display 2, words/phrases having degrees of priority equal to or larger than a threshold, among the words/phrases whose beginning parts match the character (s) entered by the user.

For example, the threshold is set to 100 points. If “eager” has 350 points, “efficiency” has 120 points, and “eight” has 10 points as shown in FIG. 6, “eager” and “efficiency” may be displayed on the main display 2 as candidates to be searched for, whereas “eight” is not displayed.

The threshold of degree of priority may be set to any value as appropriate.

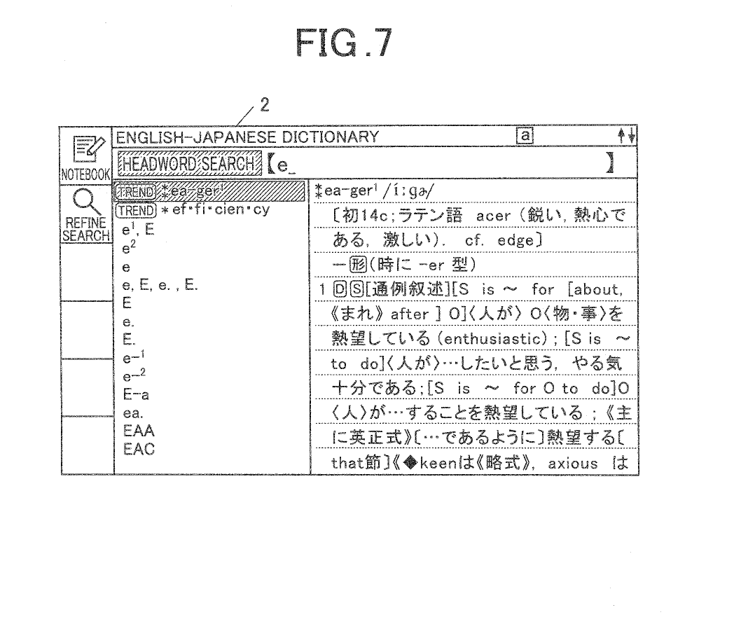

The candidates to be searched for are preferably displayed in an upper part of the display section (see FIG. 7).

The number of candidates to be searched for and to be displayed may be set to any number and may be changed as appropriate. Words/phrases displayed as candidates to be searched for may be distinguished from other words/phrases on the display using, for example, icons or commas.

If the aggregate list 59 no longer includes any word/phrase whose beginning part matches characters entered by the user as the number of characters entered by the user increases to two, three, . . . , the CPU 40 performs only a normal search of dictionaries for the headword.

The CPU 40 then determines whether the history list 58 has been updated in the user's own electronic dictionary 1 and whether the history lists 58 of other users' electronic dictionaries 1 have been updated (Step S6). When a new word/phrase that is not included in a history list 58 is searched for or when a word/phrase that is already included in a history list 58 is searched for again, the word/phrase and the corresponding search date and time, elapsed time, and points are added to the relevant history list 58. In Step S6, the CPU 40 determines existence or non-existence of such added information and thus determines whether each history list 58 has been updated.

If the CPU 40 determines that a history list (s) 58 has been updated in one of or both of the user's own electronic dictionary 1 and the other users' electronic dictionaries 1, the CPU 40 repeats Step S1 and the subsequent steps. If, on the other hand, the CPU 40 determines that none of the history lists 58 has been updated in the user's own electronic dictionary 1 and the other users' electronic dictionaries 1, the CPU 40 carries out other processes (Step S7).

### [Example Operation]

Suppose that five electronic dictionaries 1 of the students A to E are connected with one another for mutual communication, the student A's aggregate list 59 includes “eager”, “efficiency”, and “eight” with their degrees of priority being calculated to be “eager” (high)>“efficiency” (medium)>“eight” (low), the degrees of priority of “eager” and “efficiency” are each equal to or larger than a threshold, and that the degree of priority of “eight” is less than the threshold (Steps S1 to S3).

In such a state, if student A enters “e” for a headword (Step S4) as shown in FIG. 7, “eager” and “efficiency” are displayed in this order on the main display 2 as candidates to be searched for (Step S5). On the left of each of the words “eager” and “efficiency”, an icon of “trend” is displayed. This icon indicates that the word/phrase having the icon has been searched for very recently or multiple times by one or more of students A to E.

According to the embodiment described above, the history information of words/phrases is shared by the multiple electronic dictionaries 1 connected with one another for mutual communication, and words/phrases searched for in class (i.e., words/phrases searched for very recently) and words/phrases searched for in homework the previous day (i.e., words/phrases searched for multiple times) are displayed on the main display 2 as candidates to be searched for. Such a configuration allows a user to search for a word/phrase without entering all the characters of the word/phrase, leading to reduction in time required for the search.

If the words/phrases displayed on the main display 2 as candidates to be searched for are limited to words/phrases having degrees of priority equal to or larger than a threshold, the scope of the search for a word/phrase is narrowed, reducing the time and effort for selection of a word/phrase to be searched for.

In Step 2 of FIG. 5, the CPU 40 may obtain the history lists 58 of the other users' electronic dictionaries 1, weight one (or more) of the history lists 58 in accordance with user information of the user of the electronic dictionary 1 from which the history list 58 has been obtained, and correct the aggregate list 59. The term “user information” refers to information on test scores (e.g., TOEIC scores) of a user, information on whether or not the user is a friend, information on the grade of the user, and/or any other information set as appropriate.

For example, suppose that the test scores of students A and B are close to each other and that the student A's electronic dictionary 1 has the student B's user information. In such a case, when the student A's electronic dictionary 1 obtains the student B's history list 58, the student A's electronic dictionary 1 may multiply the points in the student B's history list 58 by 1.5.

Such a correction process largely reflects the student B's search histories in the student A's searches for words/phrases. The students who are similar in foreign language ability can thus share information with each other and can mutually enhance learning efficiency.

In Step S3, the CPU 40 may increase the degree of priority of a word/phrase in the aggregate list 59 if the word/phrase has been registered in a vocabulary list, highlighted, or assigned with a headword note.

For example, in the case in which student B has registered “eager” in a vocabulary list, the points of “eager” (e.g., 100 points) may be doubled (into e.g., 200 points) and the aggregate list 59 may be created using the doubled points. By contrast, in the case in which student A has already registered a word/phrase, the word/phrase may be omitted from the aggregate list 59 based on the presumption that student A is less likely to search for the word/phrase.

The CPU 40 may decrease the degree of priority of a word/phrase in the aggregate list 59 if the word/phrase has already been searched for.

For example, in the case in which the student A's history list 58 includes “eager”, the points of “eager” may be reduced by the points of “eager” in the student A's history list 58 or may be reduced to 0 point, and the aggregate list 59 may be created using the reduced points. That is, if student A has already searched for a word/phrase, the degree of priority of the word/phrase may be decreased as the search date and time of the word/phrase is closer to the current date and time.

Such a configuration can prevent a word/phrase which has already been searched for and memorized by student A from being displayed as a candidate to be searched for.

Further, in the case in which “eager” is included in the student A's aggregate list 59 and in which student A has searched for “eager” again, the points of “eager” (e.g., 350 points) may be reduced to one-half (into e.g., 175 points) and the aggregate list 59 may be created using the reduced points.

In this embodiment, the number of candidates to be searched for and to be displayed may be set to any number as shown in, for example, Step S5 of FIG. 5. So, the number of candidates to be searched for and to be displayed can be changed in accordance with the number of users (i.e., the number of electronic dictionaries 1 connected with one another for mutual communication).

An embodiment to which the present invention is applied is not limited to the embodiment and the modifications described above. The present invention may be modified as appropriate without departing from the spirit of the present invention.

For example, in the embodiment described above, an information display device according to the present invention is applied to an electronic dictionary 1. A device to which the present invention can be applied, however, is not limited to such a product. The present invention can be applied to general electronic devices, such as tablet personal computers (or smartphones), desktop personal computers, laptop personal computers, mobile phones, personal digital assistants (PDAs), and gaming machines.

The information display program according to the present invention may be stored in a memory card or a compact disk (CD) removable from one of these electronic devices including an electronic dictionary 1. Alternatively, the information display program according to the present invention may be provided through a communications line including a carrier wave.

The present invention is not limited to the embodiment described above but includes the scope of claims and the equivalents thereof.

The entire disclosure of Japanese Patent Application No. 2014-192101 filed on Sep. 22, 2014 including description, claims, drawings, and abstract are incorporated herein by reference in its entirety.

Although an exemplary embodiment has been shown and described, the invention is not limited to the embodiment shown. Therefore, the scope of the invention is intended to be limited solely by the scope of the claims that follow.

What is claimed is:

1. An information display device comprising:
a communication unit which communicates with another device;
a display unit;
a memory; and
a processor which performs:
a transmitting process to transmit a search history of the information display device to the another device via the communication unit,
a receiving process to receive a search history of the another device via the communication unit, and
a control process to display, as a candidate to be searched for on the display unit, a word and/or phrase included in the search history received by the receiving process.

2. The information display device according to claim 1, further comprising a key input unit, wherein
the processor performs:
a dictionary search process to search for a word and/or phrase and to output explanatory information on the word and/or phrase on the basis of a character entered through the key input unit, and
a search history storing process to store the search history in the memory, the search history including the word and/or phrase searched for by the dictionary search process and information on a search time at which the word and/or phrase is searched for, wherein
the transmitting process performed by the processor transmits the search history stored by the search history storing process in the information display device to the another device; and
the receiving process performed by the processor receives the search history stored by a search history storing process in the another device.

3. The information display device according to claim 2, wherein
the processor performs:
an aggregate data creation process to collect the word and/or phrase included in the search history of the another device received by the receiving process, to calculate a degree of priority of the word and/or phrase on the basis of the information on the search time, and to store, in the memory, the collected word and/or phrase and the degree of priority associated with each other.

4. The information display device according to claim 3, wherein
the control process performed by the processor displays, as the candidate to be searched for on the display unit, the word and/or phrase whose beginning part matches the character entered by a user among the word and/or phrase included in the search history received by the receiving process, in an order of the degree of priority.

5. The information display device according to claim 4, wherein
the control process performed by the processor displays, as the candidate to be searched for on the display unit, the word and/or phrase which has the degree of priority equal to or larger than a threshold among the word and/or phrase whose beginning part matches the character entered by the user.

6. The information display device according to claim 3, wherein
the aggregate data creation process performed by the processor decreases the degree of priority of the word and/or phrase included in the search history of the information display device on the basis of a predetermined rule.

7. An information display method using an information display device including a communication unit which communicates with another device, a display unit, and a memory, the method comprising:
a transmitting step to transmit a search history of the information display device to the another device via the communication unit,
a receiving step to receive a search history of the another device via the communication unit, and
a control step to display, as a candidate to be searched for on the display unit, a word and/or phrase included in the search history received by the receiving step.

8. The information display method according to claim 7, further comprising:
a key input step to receive a key input;
a dictionary search step to search for a word and/or phrase and to output explanatory information on the word and/or phrase on the basis of a character entered by the key input step, and
a search history storing step to store the search history in the memory, the search history including the word and/or phrase searched for by the dictionary search step and information on a search time at which the word and/or phrase is searched for, wherein
the transmitting step transmits the search history stored by the search history storing step in the information display device to the another device; and
the receiving step receives the search history stored by a search history storing step in the another device.

9. The information display method according to claim 8, further comprising an aggregate data creation step to collect the word and/or phrase included in the search history of the another device received by the receiving step, to calculate a degree of priority of the word and/or phrase on the basis of the information on the search time, and to store, in the memory, the collected word and/or phrase and the degree of priority associated with each other.

10. The information display method according to claim 9, wherein
the control step displays, as the candidate to be searched for on the display unit, the word and/or phrase whose beginning part matches the character entered by a user among the word and/or phrase included in the search history received by the receiving step, in an order of the degree of priority.

11. The information display method according to claim 10, wherein
the control step displays, as the candidate to be searched for on the display unit, the word and/or phrase which has the degree of priority equal to or larger than a threshold among the word and/or phrase whose beginning part matches the character entered by the user.

12. The information display method according to claim 9, wherein
the aggregate data creation step decreases the degree of priority of the word and/or phrase included in the search history of the information display device on the basis of a predetermined rule.

13. A storage medium having stored therein a program to allow a computer of an information display device including a communication unit which communicates with another device, a display unit, and a memory, to perform:
a transmitting process to transmit a search history of the information display device to the another device via the communication unit,
a receiving process to receive a search history of the another device via the communication unit, and
a control process to display, as a candidate to be searched for on the display unit, a word and/or phrase included in the search history received by the receiving process.

14. The storage medium according to claim 13, further having stored therein a program to allow the computer to perform:
a dictionary search process to search for a word and/or phrase and to output explanatory information on the word and/or phrase on the basis of a character entered by a key input, and
a search history storing process to store the search history in the memory, the search history including the word and/or phrase searched for by the dictionary search process and information on a search time at which the word and/or phrase is searched for, wherein
the transmitting process transmits the search history stored by the search history storing process in the information display device to the another device; and
the receiving process receives the search history stored by a search history storing process in the another device.

15. The storage medium according to claim 14, further having stored therein a program to allow the computer to perform:
an aggregate data creation process to collect the word and/or phrase included in the search history of the another device received by the receiving process, to calculate a degree of priority of the word and/or phrase on the basis of the information on the search time, and to store, in the memory, the collected word and/or phrase and the degree of priority associated with each other.

16. The storage medium according to claim 15, wherein
the control process displays, as the candidate to be searched for on the display unit, the word and/or phrase whose beginning part matches the character entered by a user among the word and/or phrase included in the search history received by the receiving process, in an order of the degree of priority.

17. The storage medium according to claim 16, wherein
the control process displays, as the candidate to be searched for on the display unit, the word and/or phrase which has the degree of priority equal to or larger than a threshold among the word and/or phrase whose beginning part matches the character entered by the user.

18. The storage medium according to claim 15, wherein
the aggregate data creation process decreases the degree of priority of the word and/or phrase included in the search history of the information display device on the basis of a predetermined rule.
